(19) United States
(12) Patent Application Publication
(10) Pub. No.: US 2016/0137847 A1
(43) Pub. Date: May 19, 2016

(54) TRANSPARENT, OPTICALLY VARIABLE INTERFERENCE PIGMENTS HAVING ELECTRICALLY SEMICONDUCTING PROPERTIES

(71) Applicant: MERCK PATENT GMBH, Darmstadt (DE)

(72) Inventor: Reinhold RUEGER, Roedermark (DE)

(73) Assignee: Merck Patent GmbH, Darmstadt (DE)

(21) Appl. No.: 14/898,851

(22) PCT Filed: May 28, 2014
(86) PCT No.: PCT/EP2014/001436

§ 371 Date: Dec. 16, 2015

(30) Foreign Application Priority Data
Jun. 17, 2013 (EP) 13003083.6

(51) Int. Cl. C09C 1/00

(52) U.S. Cl. CPC C09C 1/0027; C01P 2006/40; C09C 2200/1004; C09C 2200/102; C09C 2200/302

(57) ABSTRACT

The present invention relates to transparent, optically variable, electrically semiconducting interference pigments, in particular flake-form interference pigments, which comprise an oxygen-deficient layer of Ti0₂₋ₓ, to a process for the preparation of such pigments, and to the use of the pigments prepared in this way.

The present invention relates to transparent, optically variable, electrically semiconducting interference pigments, in particular flake-form interference pigments, which comprise an oxygen-deficient layer of TiO₂₋ₓ, to a process for the preparation of such pigments, and to the use of the pigments prepared in this way.

Pigments having angle-dependent interference colours (colour flop, optically variable behaviour) have manifold applications today for attractive colouring in high-quality goods, such as branded articles, packaging, sports clothing, cosmetics, and especially in non-copyable security features for security products, such as bank notes, tickets, revenue stamps and the like. Pigments available for this purpose often have a multilayered structure comprising various materials of different refractive indices on suitable support materials.

Although the optically variable security features obtainable with these pigments are readily discernible with the naked eye, but cannot be copied, they are not sufficient for high-security applications, such as bank note printing, in order to establish counterfeiting security. For this reason, optically variable effects have recently frequently also been combined with functional effects, such as magnetism, fluorescence, electrical conductivity or also electroluminescence, in order to be able better to meet the requirements of counterfeiting protection and non-copyability of security products. In the simplest case, individual pigments, which each have different functions or colour properties, are combined with one another for this purpose.

Thus, for example, EP 1 748 903 describes a machine-readable, electroluminescent security feature in which transparent electrically conducting pigments and electroluminescent pigments are used together in a coating in order to generate electroluminescence as hidden security feature. This can be extended into a combined visible/hidden security feature by admixing optically variable pigments. The transparent electrically conducting pigments used here have high conductivity and preferably consist of mica coated with antimony-doped tin dioxide.

EP 0 960 912 also discloses applications in which optically variable pigments are mixed with electrically conducting pigments based on mica/(Sb,Sn)O₂ in the application medium in order advantageously to combine the two effects with one another.

Although the (Sb,Sn)O₂-coated mica here is substantially transparent, it has, however, an inherent colour (absorption colour), albeit a pale one. This and the light scattering caused by the conducting pigments result in colour shifts or in weakening of the colour change effect (colour flop) in the coating comprising the pigments.

It would therefore be advantageous to have available pigments which have both optically variable colour properties and also readily controllable electrical conductivity.

It is known that titanium suboxides have a certain electrical conductivity. Furthermore, the prior art discloses pigments which are also coated, inter alia, with titanium suboxides on a suitable support material.

Thus, DE 199 53 655 discloses goniochromatic lustre pigments which have a titanium suboxide-containing layer and further low- and high-refractive-index layers on silicate flakes. The titanium suboxides provide the pigments with a blue absorption colour and increased hiding power. Due to the covering of the titanium suboxide layer with a plurality of dielectric layers, specific generation of a certain electrical conductivity is not expected and is also not part of this invention.

EP 1 114 104 discloses optically variable pigments based on SiO₂ which comprise titanium dioxide, titanium suboxides and further oxides or oxy-nitrides on the SiO₂ support. The reduction using a solid reducing agent provides the pigments with hiding power and absorption colour besides the optical variability. The electrical conductivity of the pigments that is optionally present is not a subject-matter of the investigations.

The pigments described in the two last-mentioned documents have dark mass tones, meaning that they are not suitable for transparent coatings or printed layers, in particular on a white background.

According to WO 2009/077122, it is possible to obtain optically variable pigments having high conductivity which have an electrically conducting coating, which preferably consists of antimony-doped tin oxide, on a substrate, which preferably consists of SiO₂. However, the pale absorption colour of these pigments may still be regarded as interfering in demanding applications, in particular in the high-security area. In addition, semiconducting properties are also more suitable than high electrical conductivity of additives for specific applications.

There is therefore still a need for transparent, electrically conducting interference pigments which have attractive bright interference colours at the same time as angle dependence of the interference colours (optically variable behaviour) and an only slight, in particular no, mass tone (absorption colour) and whose electrical properties can be adjusted specifically in the semiconducting region.

The object of the present invention is to provide a transparent interference pigment having bright, optically variable interference colours and defined electrically semiconducting properties which has no or only extremely low inherent absorption.

A further object of the present invention consists in indicating the use of pigments of this type.

In addition, it is also an object of the present invention to provide a security product which contains the interference pigments described.

The object of the present invention is achieved by transparent, optically variable, electrically semiconducting, flake-form interference pigments based on a flake-form, transparent support with at least one layer comprising a titanium oxide on the support, where
a) the flake-form support has a thickness of at least 80 nm and consists of at least 80% by weight, based on the total weight of the support, of silicon dioxide and/or silicon dioxide hydrate, and where an outer layer of TiO₂₋ₓ where 0.001≦x<0.05 is located on the support, or
b) the flake-form support is coated at least with a layer package comprising
   a first layer comprising a colourless material having a refractive index n≧1.8,
   a second layer comprising a colourless material having a refractive index n<1.8 and a geometrical layer thickness of ≧50 nm, and
   a third, outer layer comprising a colourless material having a refractive index n≧1.8,
where at least the third, outer layer consists of TiO₂₋ₓ and where 0.001≦x<0.05.

Furthermore, the object of the invention is achieved by the use of the interference pigments described above in paints, coatings, printing inks, plastics, sensors, security applications, floorcoverings, textiles, films, ceramic materials, glasses, paper, for laser marking, in heat protection, as photosemiconductors, in pigment-containing formulations, pigment preparations and dry preparations.

In addition, the object of the present invention is also achieved by a security product which contains the interference pigments according to the invention.

The present invention relates to a transparent, electrically semiconducting, optically variable, flake-form interference pigment which is based on a flake-form support and is coated with one or more optically active layers, where in each case at least the outer layer of the coating on the support consists of a titanium oxide of the composition TiO₂₋ₓ, where: 0.001≦x<0.05. A composition of this type is not a titanium suboxide, but instead an oxygen-deficient titanium dioxide. Since the formation of lower titanium oxides, titanium suboxides or Magnéli phases, such as TiO, Ti₂O₃ , Ti₃O₅, Ti₂O, Ti₃O, Ti₆O or TiₙO₂ₙ₋₁, is always accompanied by inherent absorption of the layers comprising them, it is of particular importance in accordance with the present invention that the layer consisting of TiO₂₋ₓ does not comprise lower titanium oxides, titanium suboxides or Magnéli phases of this type. Particular preference is given to a composition of the TiO₂₋ₓ layer of TiO_{1.96} to TiO_{1.99}, where: 0.01≦x≦0.04.

The transparency T of interference pigments can be determined via lightness values L* of coatings which comprise the interference pigments on black/white paint cards. The measurements are carried out in the CIEL*a*b* colour space by means of a suitable measuring instrument, for example an ETA device (STEAG-ETA Optic GmbH, Inc.) The measurements are carried out at the mass tone angle 45°/90° in each case over the coated black and white paint card. The transparency T which can be determined is inversely proportional to the hiding power and can be determined in accordance with the following equation:

T=(L*_{45/90/white}−L*_{45/90/black})/100.

(Determination of the hiding power HP by the Hofmeister method (Colorimetric evaluation of pearlescent pigments, “Mondial Coleur 85” congress, Monte carlo, 1985, in accordance with equation HP=100/(L*_{45/90/white}−L*_{45/90/black})).

The interference pigments according to the invention have a transparency, determined in accordance with the above-mentioned equation, of >0.35, preferably of >0.40.

The interference pigments according to the invention preferably have only a very slight and preferably no mass tone (absorption colour).

A measure of the mass tone is the above-mentioned measurement of the L* value at an angle of 45°/90° over the white paint card.

Since each mass tone reduces the reflection over white and thus the obtainable L* value and the interference pigments according to the invention may only have a very slight to no mass tone, the L* value over white at) 45°/90° (=45°/0°) of the pigments according to the invention with a pigment application rate of 5 g/m² is at a value L*≧70 and is thus very high.

The term flake-form is applied to pigments or support materials if their outer shape corresponds to a flat structure which, with its top and bottom, has two surfaces which are approximately parallel to one another and whose length and width dimension represents the greatest dimension of the pigment or support material. The separation between the said surfaces, which represents the thickness of the flake, has, by contrast, a smaller dimension.

The length and width dimension of the pigments here is between 2 and 250 μm, preferably between 2 and 100 μm, and in particular between 5 and 60 μm. It also represents the value which is usually called the particle size of the interference pigments. This is not critical per se, but a narrow particle size distribution of the interference pigments according to the invention is preferred. A reduced fines content is particularly preferred. The content of particles having a particle size below 10 μm here is <5% by weight, based on the total weight of the pigments. The d₉₀ value is preferably in the range from 40 to 45 μm.

The particle size and particle size distribution can be determined by various methods which are usual in the art. However, preference is given in accordance with the invention to the use of the laser diffraction method in a standard method by means of a Malvern Mastersizer 2000, APA200 (product from Malvern Instruments Ltd., UK). These methods has the advantage that particle size and particle size distribution can be determined simultaneously under standard conditions.

The particle size and the thickness of individual particles can in addition be determined with the aid of SEM (scanning electron microscope) images. In these, particle size and geometrical particle thickness can be determined by direct measurement. In order to determine average values, at least 1000 particles are evaluated individually and the results are averaged.

The thickness of the interference pigments is between 0.3 and 4 μm, in particular between 0.5 and 3 μm.

The interference pigments according to the invention have a form factor (ratio of length or width to thickness) in the range from 2:1 to 500:1, preferably in the range from 20:1 to 300:1.

For the purposes of the present invention, a pigment is regarded as electrically semiconducting if it has a specific powder resistance in the range from 0.1 to 100 megaohm*cm. The interference pigments according to the invention preferably have a specific powder resistance in the range from 1 to 80 megaohm*cm, in particular in the range from 10 to 60 megaohm*cm. The values indicated here relate to field strengths of up to 10 V/mm, where the field strength relates to the applied measurement voltage.

The measurement of the specific powder resistance is carried out here by compressing an amount of in each case 0.5 g of pigment against a metal electrode with the aid of a weight of 10 kg with a metal ram in an acrylic glass tube having a diameter of 2 cm. The electrical resistance R is measured on the pigments compressed in this way. The layer thickness L of the compressed pigment gives the specific resistance ρ in accordance with the following relationship:

ρ=R*π*(d/2)²/L (ohm*cm).

Optically variable pigments are pigments which leave behind a different visually perceptible colour and/or brightness impression at different illumination and/or viewing angles. In the case of different colour impressions, this property is known as colour flop. The optically variable pigments according to the invention preferably have at least two and at most four optically clearly distinguishable discrete colours at at least two different illumination and/or viewing angles, but preferably two optically clearly distinguishable discrete colours at two different illumination and/or viewing angles or three optically clearly distinguishable discrete colours at three different illumination and/or viewing angles. In each case, only the discrete hues and no intermediate hues are preferably present, i.e. a clear change from one colour to another colour is evident at different viewing angles. However, embodiments which exhibit a colour progression on changing the viewing angle are also suitable.

In a first embodiment (a), the transparent, flake-form interference pigment in accordance with the present invention consists of a flake-form support which has a thickness of at least 80 nm and consists of at least 80% by weight, based on the total weight of the support, of silicon dioxide and/or silicon dioxide hydrate, where the support is coated with at least one layer which consists of TiO₂₋ₓ where 0.001≦x<0.05 and where this layer represents at least the outer layer on the support.

The flake-form support consists of at least 80% by weight, based on the total weight of the substrate, of silicon dioxide and/or silicon oxide hydrate. The support preferably consists of 95 to virtually 100% by weight of silicon oxide and/or silicon oxide hydrate, where only traces or low percentage proportions of foreign ions may be present.

Such supports are also known as SiO₂ flakes, even if they comprise proportions of hydrated silicon oxide. They are highly transparent and colourless. They have flat and very smooth surfaces and a uniform layer thickness. Due to the preferred production process for the SiO₂ flakes which is described below, they have sharp fracture edges, which may have pointy, tooth-like protuberances, on the side surfaces. Particular preference is given to supports which have a narrow particle size distribution, in particular those in which the proportion of fine particles is minimised, as already described above.

In the simplest variant of the first embodiment of the present invention, the pigment according to the invention consists of the SiO₂-containing support described above and a layer of TiO₂₋ₓ in the above-mentioned composition and with the above-mentioned dimensions surrounding the support. Due to the simple layer structure, this variant of the first embodiment is particularly preferred. TiO₂₋ₓ here can be both in the anatase and also in the rutile modification. The starting material for the preparation of pigments of this type are flake-form, TiO₂-coated SiO₂ pigments, which are commercially available and are marketed, for example, by Merck KGaA Darmstadt under the trade name Colorstream®. However, pigments of this type can also be prepared by the process described in WO 93/08237. However, the pigments prepared analogously to this process should not contain any dissolved or undissolved colorants. The support flakes are produced from the corresponding, preferably inorganic, SiO₂ precursor material (for example sodium water-glass solution) in a belt process, in which the precursor is applied to the belt, converted into the oxidic form or into the oxide hydrate using acid, solidified and subsequently detached from the belt. The geometrical layer thickness of the flakes is adjusted via the application rate or wet layer thickness of the precursor layer, which is possible very precisely. The SiO₂ flakes are subsequently coated with TiO₂ by a wet-chemical process, which is likewise described in WO 93/08237. The TiO₂ here can be in the anatase or rutile modification. The conversion of TiO₂ into TiO₂₋ₓ in accordance with the present invention is described below.

The particle size of the SiO₂ support flakes is in the same range as the particle sizes indicated above for the interference pigments according to the invention, namely in the range between 2 and 250 μm, preferably between 2 and 100 μm, and in particular between 5 and 60 μm. The thickness of the support flakes is at least 80 nm and up to 4 μm, preferably 80 nm to 1 μm, in particular 80-700 nm, and very particularly preferably 180 to 550 nm. At a thickness below 80 nm with a single layer of TiO₂₋ₓ on the support, optically variable colour behaviour of the pigments formed would not be guaranteed. Support thicknesses greater than 4 μm result, in particular in the case of a multilayered structure, in very thick interference pigments, which can only be aligned with difficulty in the application media and thus likewise reduce the optically variable behaviour.

In a second variant of the first embodiment, the flake-form support likewise consists of at least 80% by weight, based on the total weight of the support, of silicon dioxide and/or silicon dioxide hydrate, and a layer sequence comprising at least three layers is applied to the support, where
a first layer consists of a colourless material having a refractive index n≧1.8,
a second layer consists of a colourless material having a refractive index n<1.8, and
a third, outer layer consists of a colourless material having a refractive index n≧1.8,

where at least the third, outer layer consists of TiO₂₋ₓ and where 0.001≦x<0.05.

The materials which are suitable for the first and second layer are explained below.

However, at least the third, outer layer consists of TiO₂₋ₓ where 0.001≦x<0.05. This layer, just like a layer of stoichiometric TiO₂, represents a colourless layer comprising a high-refractive-index material, since TiO₂₋ₓ, just like TiO₂, has a refractive index in the range from 2.0 to 2.7. The specific refractive index of the material also depends, in particular, on the crystal modification in which the TiO₂₋ₓ exists. The rutile modification here has a higher refractive index than the anatase modification and is therefore preferred. This applies to all embodiments of the present invention.

In a second embodiment of the present invention (b), a layer package comprising at least three layers comprising colourless materials of alternating high and low refractive index according to claim 1 is located on a flake-form support, where at least the outer, third layer consists of TiO₂₋ₓ where 0.001≦x<0.05.

Compared with the second variant of the first embodiment, the second embodiment of the present invention is distinguished by different support materials and a limitation of the layer thickness of the second layer comprising a colourless material having a refractive index n<1.8.

Suitable as support material for the second embodiment are natural or synthetic mica flakes, kaolin, sericite or talc flakes, glass flakes, borosilicate flakes, Al₂O₃ flakes or mixtures of two or more thereof. Natural or synthetic mica flakes are particularly preferred. The particle size of the support flakes is in the same range as the particle sizes indicated above for the interference pigments according to the invention, namely in the range between 2 and 250 μm, preferably between 2 and 100 μm, and in particular between 5 and 60 μm.

The thickness of these support flakes is in the range from 0.2 to 1.5 μm, in particular in the range from 0.3 to 1 μm.

Due to the difference of the support flakes in the second embodiment of the present invention, optically variable behaviour of the resultant interference pigments cannot be ensured due to the support material. The second coating in the layer package on the support, which consists of a colourless material having a refractive index n<1.8, therefore has a geometrical layer thickness (dry layer thickness) of at least 50 nm, in particular in the range from 50 to 300 nm and particularly preferably in the range from 120 to 250 nm.

This high layer thickness of the low-refractive-index layer results, in the case of all support materials mentioned above, in optically variable colour behaviour of the resultant pigments if the layer thicknesses of the high-refractive-index layers (n≧1.8) are matched thereto.

Suitable as material for the second layer comprising a material having a refractive index n<1.8, both for the first and also for the second embodiment of the present invention, are SiO₂, Al₂O₃, silicon oxide hydrate, aluminium oxide hydrate, MgF₂, or mixtures of two or more thereof. Preference is given to the use of SiO₂, silicon dioxide hydrate or mixtures thereof. In the first embodiment, only the layer thickness of this layer is not subject to any particular limitations, but instead can be in the range from 1 to 300 nm, preferably 50 to 250 nm.

The colourless material having a refractive index≧1.8 for the first layer in the layer package on the support flakes can be selected from TiO₂, titanium dioxide hydrate, ZnO, ZrO₂ and/or mixed phases thereof, or alternatively likewise from TiO₂₋ₓ where 0.001≦x<0.05. This applies both to the first and also to the second embodiment of the present invention.

This material is preferably selected from TiO₂, titanium dioxide hydrate or TiO₂₋ₓ. TiO₂ and TiO₂₋ₓ are each in a crystalline phase here, more precisely in the anatase or rutile modification. Owing to the higher refractive index, the rutile modification is preferred.

Preference is given here both to the variant in which the first layer in the layer package on the support flake consists of TiO₂ and also the variant in which all layers comprising a colourless material having a refractive index n≧1.8 consist of TiO₂₋ₓ where 0.001≦x<0.05.

The layer thicknesses of all layers comprising a material having a refractive index n≧1.8, i.e. the first and third layers in the layer package of the first and second embodiment, is, irrespective of the respective materials, in each case 50 to 200 nm, in particular 60 to 100 nm, and is set in an expert manner depending on the desired colour combination of the interference colours of the pigments according to the invention.

It is known to the person skilled in the art that a rutile modification of TiO₂ can be favoured by doping the layer with SnO₂ or by underlayering a TiO₂ layer with a layer of SnO₂. This also applies to the oxygen-deficient TiO₂₋ₓ layer in accordance with the present invention. An additional layer of SnO₂ is therefore advantageously located between the transparent, flake-form support and the layer of TiO₂₋ₓ and/or directly below each layer of TiO₂ or TiO₂₋ₓ in the respective layer package of the first and second embodiment of the present invention.

For the induction of a rutile crystal phase in the TiO₂₋ₓ layer or TiO₂ layer, it is sufficient if an SnO₂ layer having a very low layer thickness is present below the TiO₂₋ₓ layer or TiO₂ layer. The geometrical layer thickness of this SnO₂ layer is therefore in the range from 0.5 to 15 nm, in particular from 1 to 10 nm, by means of which this layer represents an optically inactive layer.

As an alternative or in addition to an SnO₂ layer of this type, the TiO₂₋ₓ layer or TiO₂ layer may in a preferred embodiment be doped with 0.1 to 3 mol % of Sn.

The first to third layers in the layer package on the support flakes of the first and second embodiment of the present invention preferably in each case represent all optically active layers. Optically active layers in interference pigments are regarded as being those layers which, owing to their optical thickness (product of geometrical thickness and refractive index of the material), are able to make an independent contribution to the interference colour. This can in each case be the reinforcement, attenuation or also extinction of the reflection of light of a certain wavelength. This is the case from a geometrical layer thickness of about 10 nm in the case of high-refractive-index materials (n≧1.8), whereas it is only the case from a geometrical layer thickness of about 20 nm in the case of low-refractive-index materials (n<1.8).

Only the layer comprising a material having a refractive index<1.8 in the first embodiment of the present invention does not necessarily have to meet this condition, but advantageously does meet it.

The optically active layers do not include, for example, conventional post-coatings, which may be of both an inorganic and also organic nature and if necessary enable better incorporation of pigments into the respective application media.

The variants in the two embodiments of the present invention in which both the first and also the third layer in the layer package on the support flakes consist of TiO₂₋ₓ have, in particular, the advantage that the electrical conductivity of the respective TiO₂₋ₓ layers can be varied. Since TiO₂ must be converted into TiO₂₋ₓ separately in each of these layers, the different setting of the conditions for the requisite reduction reaction in each case means that the oxygen deficit in the individual layers may vary greatly. If the oxygen deficit in the first TiO₂₋ₓ layer is reduced, the transparency of the entire pigment increases further without the overall conductivity of the interference pigment according to the invention being greatly reduced, since the conductivity of the pigments is essentially determined by the conductivity of the outer layer.

The preparation of the interference pigments according to the invention is carried out essentially in the same manner as the preparation of conventional interference pigments, which is carried out by application of high- and low-refractive-index materials in layers to suitable support flakes. Regarding the at least outer TiO₂₋ₓ layer, a transparent, flake-form interference pigment which consists of a coated transparent, flake-form support which has a layer of TiO₂ on its outer surface, is thermally treated in a gas phase with addition of a reducing gas over a period in the range from 5 to 60 minutes, where the TiO₂ is converted into TiO₂₋ₓ and 0.001≦x<0.05. x is particularly preferably set in the range 0.01≦x≦0.04.

The process for the production of TiO₂₋ₓ layers of this type is described in greater detail in the patent application EP 13 003 084.4 by the same applicant filed in parallel. To this extent, the contents of this patent application are incorporated herein by way of reference.

The starting material for the process for the production of a TiO₂₋ₓ layer on the interference pigments according to the invention is a flake-form interference pigment which consists of a flake-form support which is coated with a TiO₂ layer at least on its outer surface.

TiO₂ or TiO₂ layer here also denotes a material or layer which consists entirely or predominantly of titanium dioxide hydrate, since drying of the corresponding oxide hydrate layer without calcination does not always reliably lead to a titanium dioxide layer, but instead may consist of titanium dioxide hydrate or have a mixed composition comprising titanium dioxide and titanium dioxide hydrate. The applied and dried titanium dioxide layer may be subjected to the process described below directly after drying, but it may also firstly be calcined at elevated temperature under air and subjected to a reducing treatment in a further step.

The preparation of interference pigments which are coated at least with an outer layer of TiO₂ on a support is carried out by the conventional processes for the preparation of interference pigments, preferably by means of wet-chemical processes. These are described, for example, in the specifications DE 14 67 468, DE 19 59 998, DE 20 09 566, DE 22 14 545, DE 22 15 191, DE 22 44 298, DE 23 13 331, DE 25 22 572, DE 31 37 808, DE 31 37 809, DE 31 51 355, DE 32 11 602 and DE 32 35 017.

To this end, the substrate flakes are suspended in water. A TiO₂ layer is preferably applied here analogously to the process described in U.S. Pat. No. 3,553,001. In this process, an aqueous titanium salt solution is slowly added to a suspension of the pigment to be coated, the suspension is heated to 50 to 100° C., and the pH is kept virtually constant in the range from 0.5 to 5.0 by simultaneous addition of a base, for example an aqueous ammonium hydroxide solution or an aqueous alkali-metal hydroxide solution. When the desired TiO₂ layer thickness on the pigment flakes has been reached, the addition of the titanium salt solution and the base is terminated. Since the titanium salt solution is added so slowly that quasi-complete deposition of the hydrolysis product on the pigment flakes takes place, there are virtually no secondary precipitations. The process is known as the titration process.

In the case of a multilayered system in accordance with variant 2 of the first embodiment or in accordance with the second embodiment of the present invention, the application of the low-refractive-index layer comprising a material having a refractive index n<1.8, which is preferably an SiO₂ layer (may consist of silicon dioxide, silicon dioxide hydrate or a mixture thereof), is carried out, for example, as follows:

For the application of an SiO₂ layer, a sodium or potassium water-glass solution is generally employed. The precipitation of a silicon dioxide or silicon dioxide hydrate layer is carried out at a pH in the range from 6 to 10, preferably from 7 to 9.

The support particle already coated in advance with a layer which consists of TiO₂, TiO₂₋ₓ or one of the other high-refractive-index, colourless materials mentioned is preferably suspended in water, and the suspension is heated to a temperature in the range from 50 to 100° C. The pH is set in the range from 6 to 10 and kept constant by simultaneous addition of a dilute mineral acid, for example of HCl, HNO₃ or H₂SO₄. A sodium or potassium water-glass solution is added to this suspension. As soon as the desired layer thickness of SiO₂ on the coated substrate has been obtained, the addition of the silicate solution is terminated, and the batch is stirred for a further 0.5 hours.

Alternatively, a hydrolytic coating with SiO₂ can also be carried out using organic silicon compounds, such as, for example, TEOS, in an acid- or base-catalysed process via a sol-gel reaction. This is likewise a wet-chemical process.

A TiO₂ layer is in each case applied as outermost optically active layer.

The conversion of the TiO₂ layer into TiO₂₋ₓ is carried out under weakly reducing conditions in a gas stream. A reducing gas is added thereto, and the pigments are thermally treated therein over a period of 5 to 60 minutes.

If the starting pigment has a multilayered structure comprising at least three layers, where both the first and also the third layer of the layer package consists of TiO₂, as described above, the conversion of the respective TiO₂ layer into a TiO₂₋ₓ layers can be carried out by converting each of the individual layers separately into a TiO₂₋ₓ layer whose composition meets the condition 0.001≦x<0.05 (the covering with all further layers is then carried out in each case after the reduction step). However, it is also possible only to convert the third, outer layer of TiO₂ into a layer of TiO₂₋ₓ by the said reducing treatment. In the interests of high process economy, the latter variant is preferred, since the wet-chemical application process of the three layers of the respective layer package must not be interrupted and the transparency of the resultant pigments has particularly high values if only the outer layer of the interference pigments has a composition TiO₂₋ₓ where 0.001≦x<0.05.

It is advantageous if the pigments are kept in motion during the reduction. The thermal treatment here can, for example, take place in a gas-tight tubular furnace with a gas stream being passed through or in a fluidised-bed reactor while a gas mixture is passed through the fluidised bed.

It is of particular importance in accordance with the invention that no lower titanium oxides, titanium suboxides or Magnéli phases are formed during the reduction of TiO₂. The reduction is therefore monitored under very weakly reducing conditions. Thus, for example, the content of reducing gas in the gas mixture is reduced compared with generally conventional reducing conditions.

The proportion of reducing gas in the gas mixture is in the range from 0.05 to 10% by vol., based on the total volume of the gas mixture. The proportion of reducing gas here is graduated depending on the reaction temperature.

The reaction temperature employed is in the range from 400° C. to 800° C. and is thus also comparatively moderate. The higher the reaction temperature is selected, the lower the proportion of reducing gas in the gas mixture must be in order that the formation of titanium suboxides does not occur. At a lower reaction temperature in the above-mentioned range, by contrast, the content of reducing gas in the gas mixture can be selected higher.

Thus, the proportion of reducing gas in the gas mixture can be 5 to 10% by vol. at a reaction temperature of 400° C., whereas it may only be in the range from 0.05 to <5% by vol. at a reaction temperature of 800° C.

In particular, the reaction temperature and proportion of reducing gas in the gas mixture are in detail preferably matched as follows:

T≦550° C., preferably ≦500° C.: proportion of reducing gas: 5-10% by vol., in particular 5-8% by vol.,

T≦650° C., preferably ≦600° C.: proportion of reducing gas: 2-5% by vol.,

T≦750° C., preferably ≦700° C.: proportion of reducing gas: 1-2% by vol.,

T≦800° C., proportion of reducing gas: 0.05-1% by vol.

If the said conditions are observed for the reduction, there is no formation of titanium suboxides in the TiO₂ layer, but instead merely the formation of an oxygen deficit, so that the layer formed has the composition TiO₂₋ₓ, where 0.001≦x<0.05.

Only the respective anatase and/or rutile crystal modification is evident in the X-ray diffraction pattern of the corresponding pigment samples.

The reducing gas employed can be hydrogen, ammonia or hydrocarbon compounds having 1 to 4 C atoms (C₁-C₄). These are known to the person skilled in the art as reducing gases, but are generally otherwise employed with a higher proportion in the gas stream. Suitable C₁-C₄-hydrocarbon compounds are, in particular, methane, ethylene or propanone. Suitable carrier gases are, in particular, nitrogen or argon, which represent the other constituents of the gas mixture. Forming gas (N₂/H₂) having the above-mentioned low proportion of hydrogen is particularly preferably employed.

The interference pigments according to the invention can also be obtained by calcination of the starting pigments in vacuo. However, the reducing conditions and thus the final composition of the TiO₂₋ₓ layer are more difficult to monitor in this case. For this reason, a reducing treatment in vacuo is not preferred.

After the thermal treatment, the interference pigments obtained are cooled and classified either under the reducing conditions present or under protective gas.

The present invention also relates to the use of the interference pigments according to the invention in paints, coatings, printing inks, plastics, sensors, security applications, floorcoverings, textiles, films, ceramic materials, glasses, paper, for laser marking, in heat protection, as photosemiconductors, in pigment-containing formulations, pigment preparations and dry preparations.

Due to their optically variable behaviour, their high interference colour strength and transparency, the pigments according to the invention are highly suitable, merely owing to their colour properties, to be employed for the pigmentation of application media of the above-mentioned type. They are employed here in the same manner as conventional interference pigments. However, it is particularly advantageous that, besides the attractive colour properties, they also have semiconducting electrical properties, which make them suitable, in particular, for use in industrial applications which require electrically semiconducting coatings, but also very particularly for use in various security products, which occasionally require electrically conducting or semiconducting pigments in coatings in order to check security features. Security products of this type are, for example, bank notes, cheques, credit cards, shares, passports, identity documents, driving licences, entry tickets, revenue stamps, tax stamps etc., to mention but a few.

On use of the pigments in paints and coatings, all areas of application known to the person skilled in the art are possible, such as, for example, powder coatings, automobile paints, printing inks for gravure, offset, screen, or flexographic printing and paints in outdoor applications. For the preparation of printing inks, a multiplicity of binders, in particular water-soluble, but also solvent-containing types, for example based on acrylates, methacrylates, polyesters, polyurethanes, nitrocellulose, ethylcellulose, polyamide, polyvinyl butyrate, phenolic resins, melamine resins, maleic resins, starch or polyvinyl alcohol, is suitable. The paints can be water- or solvent-based paints, where the choice of the paint constituents is subject to the general knowledge of the person skilled in the art.

The pigments according to the invention can likewise advantageously be employed for the production of electrically semiconducting plastics and films, more precisely for all applications known to the person skilled in the art which require electrical semiconductivity. Suitable plastics here are all standard plastics, for example thermosets and thermoplastics. The pigments according to the invention are subject to the same conditions here as conventional pearlescent or interference pigments. Special features of the introduction into plastics are therefore described, for example, in R. Glausch, M. Kieser, R. Maisch, G. Pfaff, J. Weitzel, Pearlescent pigments, Curt Vincentz Verlag, 1996, 83 ff.

The pigments according to the invention are also suitable for the preparation of flowable pigment preparations and dry preparations which comprise one or more pigments according to the invention, optionally further pigments or colorants, binders and optionally one or more additives. Dry preparations are also taken to mean preparations which comprise 0 to 8% by weight, preferably 2 to 8% by weight, in particular 3 to 6% by weight, of water and/or of a solvent or solvent mixture. The dry preparations are preferably in the form of pearlets, pellets, granules, chips, sausages or briquettes and have particle sizes of about 0.2 to 80 mm.

Due to their semiconducting and colour properties, the interference pigments according to the invention can particularly advantageously be employed, for example, in decorative surfaces with an antistatic finish. Besides the electrical properties, which can be controlled well by the preparation process, the interference pigments according to the invention are transparent, with no inherent absorption, have high interference colour strength and exhibit clear colour changes of the interference colours at different viewing angles, so that they are ideal for use for the colouring of otherwise transparent, dielectric layers in the areas of application described above and do not have to be mixed with absorbent colorants or other effect pigments in order also to impart an attractive colouring on the application medium, besides the semiconducting properties, while retaining the transparency of the application medium.

The combination of optically attractive interference colours, a readily visible colour change at different viewing angles and semiconducting properties at the same time as overall high transparency in a single pigment makes the interference pigments according to the invention particularly suitable for use in security products. They have attractive interference colours and optically attractive colour changes in the region of clear colours, for example gold-green flops, red-green flops or blue-green flops, which were previously not available for semiconducting pigments at the same time as high transparency in the visible and near infrared region. Since the pigments according to the invention are not absorbent effect pigments, they can be combined without problems and very advantageously in security applications with interference pigments which have the same layer structure and the same colouring of the interference colours and optionally even have the same colour flop, but comprise exclusively TiO₂ layers instead of the TiO₂₋ₓ layer or the TiO₂₋ₓ layers.

Thus, it is possible to create combined security features which consist, for example, of two adjacent fields, one of which contains an interference pigment in accordance with the present invention in a coating, while the adjacent field contains a conventional interference pigment of the same size, composition, layer structure and interference colour at the specular angle at 90° in a coating, with the only difference that none of the TiO₂ layer(s) of the comparative pigment meets the condition TiO₂₋ₓ where 0.001≦x<0.05, but instead consists of stoichiometric TiO₂. Whereas the colouring at the specular angle at 90° and even the electron microscope photographs of the pigments in the first and second field entirely correspond, the two fields differ through their electrical properties, which, in the case of the field coated with the interference pigments according to the invention, can be identified as hidden security feature using detectors by, for example, measurement of the electrical resistance of the layer in the case of direct or alternating voltage, the dielectric constant, the absorption or reflection of high-frequency magnetic fields or by microwave absorption. When the product having the security feature is tilted against the light source, the field containing the pigment according to the invention exhibits, however, a second, clear interference colour, whereas the comparative field adopts an uncoloured (white-grey) coloration if other colorants are not also present in this field. However, if the interference pigments in the two fields differ merely in the presence of electrical semiconductivity in the pigment according to the invention and otherwise have the same interference colours and colour flops, the test fields differ merely with respect to their electrical properties.

Similar combinations are of course also possible with interference pigments in comparative fields which merely have the same colour properties, but a different layer structure. In addition, a wide variety of security features are possible in which the interference pigments according to the invention can be employed together either directly in the same field or in adjacent fields with interference pigments of different colours.

The interference pigments according to the invention are particularly preferably used in security products which are, for testing, subjected to the influence of an electromagnetic field. In an application of this type, the interference pigments according to the invention exhibit, for example, attenuation or also reflection of high-frequency electromagnetic fields and a specific change in the electrical flow density in an otherwise dielectric coating in the electric field. This is also the case at pigment concentrations below the percolation threshold. This is particularly advantageous in the case of checking of invisible security features for security products, since the interference pigments according to the invention can be used, for example, for deflecting field lines in electric fields, enabling local reinforcement of the electromagnetic field to be achieved (a so-called “hot spot”). With the aid of such hot spots, it is possible, for example, to cause electroluminescent substances to luminesce. The present invention therefore also relates to a security product which contains the interference pigments according to the invention.

The concentration of the interference pigments according to the invention in the respective application medium is dependent on the properties with respect to colouring and electrical conductivity desired therein and can in each case be selected by the person skilled in the art on the basis of conventional recipes.

Although the interference pigments according to the invention have attractive optical and electrically semiconducting properties and can thus be employed as the sole effect pigments in a very wide variety of applications, it is of course possible and also advantageous, depending on the application, to mix them if necessary with organic and/or inorganic colorants (in particular with white or coloured pigments) and/or electrically conducting materials and/or other, non-electrically conducting effect pigments or to employ them together therewith in an application, for example a coating.

In addition, they can also be mixed with one another in different colour combinations or with different semiconducting properties if advantages for the application arise therefrom. In particular, mixtures of two or more interference pigments which are different from one another in which each has at least one layer which corresponds to the composition TiO₂₋ₓ where 0.001≦x<0.05 may also be advantageous, where the individual interference pigments differ in the support material, in the material composition of the layers, in the number of layers, in the interference colour, in the colour flop and/or in the electrical conductivity. All these interference pigments do not necessarily have to be optically variable and thus represent interference pigments according to the invention. Instead, some of these interference pigments may also consist of interference pigments in accordance with the patent application EP 13 003 084.4 by the same applicant filed in parallel.

The mixing ratios in the case of all mixtures described above are unlimited so long as the advantageous properties of the pigments according to the invention are not adversely affected by the admixed foreign pigments. The pigments according to the invention can be mixed in any ratio with additives, fillers and/or binder systems which are usual for the application.

The pigments according to the invention have optically variable, attractive, bright interference colours of high colour strength and electrically semiconducting properties, are transparent and virtually free or entirely free from inherent absorption into the near infrared region. Besides conventional applications of semiconducting pigments, they are therefore suitable, in particular, for the generation of visible and invisible multiple security features in security applications.

The present invention is intended to be explained below with reference to examples, but is not intended to be restricted thereto.

### EXAMPLES

### Example 1

100 g of ground and classified SiO₂ flakes having a thickness of 520 nm (particle size 10-60 μm) are suspended in 1900 ml of demineralised water. 100 ml of a solution of 0.75 g of concentrated HCl and 8.5 g of SnCl₄ in water are slowly added to the suspension in an acidic medium at 75° C. with stirring. The pH is kept constant at 1.8 by simultaneous addition of sodium hydroxide solution. The mixture is subsequently stirred at 75° C. for a further 30 min., then coated with TiO₂ at pH 1.6 by slow addition of an aqueous TiCl₄ solution (400 g/l of TiCl₄) while keeping the pH constant using 32% sodium hydroxide solution. The coating is terminated when the desired colour end point has been reached. The reaction mixture is subsequently cooled to room temperature with stirring and neutralised. The pigments obtained are filtered off via a suction filter, washed with water and dried at 140° C.

The dried pigments are subjected to thermal treatment under the conditions shown in Table 1.

A whitish pigment powder is obtained which, after application in a coating to black board, exhibits an intensely copper-coloured interference colour at a steep viewing angle and an intensely green interference colour at a flat angle.

TABLE 1
Thermal treatment under reducing conditions

| | | | | Trans- | L* |
|---|---|---|---|---|---|
| | | Temper- | | parency | 45/90 |
| Example | Atmosphere | ature | Duration | T | (w) |
| 2 (comp.) | air | 750° C. | 30 min. | 47 | 84 |
| 3 (comp.) | N₂ | 800° C. | 30 min. | 43 | 83 |
| 4 (inv.) | N₂/H₂(0.5% of H₂) | 700° C. | 30 min. | 39 | 76 |
| 5(inv.) | N₂/H₂(0.5% of H₂) | 800° C. | 30 min. | 38 | 75 |
| 6(inv.) | N₂/H₂(5% of H₂) | 500° C. | 30 min. | 43 | 82 |
| 7(comp.) | N₂/H₂(5% of H₂) | 800° C. | 30 min. | 31 | 65 |

### Example 8

Testing of the Electrical Properties in a Coating Film:

The pigments obtained after the thermal treatment in accordance with Table 1 are dispersed in NC lacquer (12% of collodium/butyl acrylate in a solvent mixture). PET films are coated with the coating preparation. The concentration of the pigments in the dry coating layer is 48.1% by weight, the layer thickness of the coating layer is 50 μm. After drying of the coating layers, the surface resistance is measured at a measurement voltage of 1000 V with the aid of a spring-tongue electrode (1 cm electrode separation, length 10 cm). The results are shown in Table 2. A comparative coating film without conducting pigment exhibits a specific resistance of >10¹² ohm.

### Example 9

Testing of the Coloristic Properties:

Samples of the pigments in accordance with Table 1 are dispersed in NC lacquer in accordance with Example 8 (1.7% by weight of pigment in the lacquer). The lacquer is then applied to black/white cardboard with a wet layer thickness of 500 μm and dried. The dried layer has a thickness of 40 μm and a pigment mass concentration (PMC) of 12.3%. The cards are then measured in reflection using a spectrophotometer (ETA-Optik from Steag Optik) at the following angles:

45°/90° over black and white, 40°/150° (flat viewing angle) and 80°/110° (steep viewing angle) over black, where the angle 90° represents the perpendicular to the plane of the card.

The L*, a*, b* values are then determined from the raw data of the measurements. The L* value over white is a measure of the mass tone of the pigment. The difference in the values at a steep and flat viewing angle is a measure of the colour flop. The values are likewise shown in Table 2.

TABLE 2
Resistances and colorimetric values of the pigments

| | L*a*b*(b) | | | |
|---|---|---|---|---|
| Example | 40°/150° | 80°/110° | Resistance | |
| 2 (comp.) | 169.5/−66.0/67.6 | 139.1/39.1/76.8 | >1 | Tohm |
| 3 (comp.) | 174.7/−72.2/74.1 | 137.8/34.6/79.0 | >1 | Tohm |
| 4 (inv.) | 169.4/−68.5/78.8 | 135.0/35.1/88.9 | 44 | Mohm |
| 5 (inv.) | 170.0/−67.0/73.6 | 137.2/35.0/83.6 | 48 | Mohm |
| 6 (inv.) | 176.5/−72.4/73.0 | 138.1/39.1/74.5 | 37 | Mohm |
| 12 (comp.) | 165.4/−64.6/66.3 | 132.4/32.8/68.3 | 17 | Mohm |

### Example 10 (Comparison)

3-Layer System with SiO₂ Interlayer:

150 g of mica (particle size 10-60 μm) are suspended in 2 l of demineralised water. An SnCl₄ solution (5.3 g of SnCl₄) in hydrochloric acid and 280 ml of an aqueous TiCl₄ solution (400 g of TiCl₄/l) are slowly metered into this suspension at 75° C. The pH is kept constant at 1.8 throughout the addition by means of NaOH solution. When the addition is complete, the mixture is stirred at 75° C. for a further 30 min in order to complete the precipitation.

The pH of the suspension is then adjusted to 7.5 using sodium hydroxide solution, and 1140 ml of a sodium water-glass solution (about 14% by weight of SiO₂) are slowly metered in at 75° C. The pH is kept constant using 10% hydrochloric acid. When the addition is complete, the mixture is stirred at 75° C. for a further 30 min.

For deposition of the outer TiO₂ layer, the pH is adjusted to 1.8 again, and 5 g of SnCl₄ in hydrochloric acid solution are slowly metered in with stirring. TiCl₄ solution is subsequently added until the desired colour end point has been reached (about 220 ml of TiCl₄ solution, 400 g of TiCl₄/l).

The suspension is subsequently cooled, the pigment obtained is filtered off, washed with water and then calcined at 800° C. under air for 30 min.

A whitish pigment powder is obtained which, after application in a coating to black board, exhibits an intensely reddish-violet interference colour at a steep viewing angle and a golden interference colour at a flat angle. The luminance of the pigment (L*45°/90° over white) is 85, the transparency T is 46. Testing of the electrical properties shows no conductivity (specific resistance<10¹² ohm).

### Example 11

Semiconducting Pigment Having 3-Layer System:

10 g of the pigment from Example 10 are calcined at 500° C. under forming gas (5% of H₂) in a tubular furnace for 30 min and then cooled to room temperature under nitrogen. In a paint smear on black board, the pigment exhibits a virtually unchanged colour combination compared with the pigment from Example 10. The luminance of the pigment (L*45°/90° over white) is 81, the transparency T is 40. Testing of the electrical properties in accordance with Example 8 shows a specific resistance of 40 Mohm.

In order to check the TiO₂ modification, X-ray diffraction patterns of the pigment obtained are recorded. These show the titanium oxide in the rutile modification and no titanium suboxide phases.

### Example 12 (Comparison)

Strongly Reduced Pigment Having a Dark Mass Tone:

The pigment from Example 1 is calcined at 800° C. under forming gas for 45 minutes. A pigment having a darker mass tone is obtained. Paint films and paint cards of the pigment are produced and measured in accordance with Examples 8 and 9. The resistance of the film is 17 Mohm, the transparency is 31. The pigment exhibits a good colour change on viewing at a flat and steep angle, but together with a brownish-grey mass tone, which adversely affects the colour impression on a white background. By contrast, the pigments according to the invention have such a slight mass tone that the latter is not evident on viewing on a white background. The electrical resistance of the paint film which comprises the pigment according to Example 12 is only insignificantly lower than the resistances of the paint films comprising the transparent interference pigments according to the invention. For antistatic-dissipative coatings, all resistances are sufficiently low.

1. Transparent, optically variable, electrically semiconducting, flake-form interference pigments based on a flake-form, transparent support with at least one layer comprising a titanium oxide on the support, where
a) the flake-form support has a thickness of at least 80 nm and consists of at least 80% by weight, based on the total weight of the support, of silicon dioxide and/or silicon dioxide hydrate, and where an outer layer of TiO₂₋ₓ where 0.001≦x<0.05 is located on the support, or
b) the flake-form support is coated at least with a layer package comprising
a first layer comprising a colourless material having a refractive index n≧1.8,
a second layer comprising a colourless material having a refractive index n<1.8 and a geometrical layer thickness of ≧50 nm, and
a third, outer layer comprising a colourless material having a refractive index n≧1.8,
where at least the third, outer layer consists of TiO₂₋ₓ and where 0.001≦x<0.05.

2. Interference pigments according to claim 1, characterised in that the flake-form, transparent support is
a) SiO₂ flakes, or
b) natural or synthetic mica flakes, kaolin, sericite or talc flakes, glass flakes, borosilicate flakes, Al₂O₃ flakes or mixtures of two or more thereof.

3. Interference pigment according to claim 1, characterised in that it consists of a flake-form support which consists of at least 80% by weight, based on the total weight of the support, of silicon dioxide and/or silicon dioxide hydrate, and a layer of TiO₂₋ₓ surrounding the support.

4. Interference pigment according to claim 1, characterised in that it comprises a flake-form support which consists of at least 80% by weight, based on the total weight of the support, of silicon dioxide and/or silicon dioxide hydrate, and a layer sequence comprising at least three layers on the support, where
a first layer consists of a colourless material having a refractive index n≧1.8,
a second layer consists of a colourless material having a refractive index n<1.8, and
a third, outer layer consists of a colourless material having a refractive index n≧1.8,
where at least the third, outer layer consists of TiO₂₋ₓ and where 0.001≦x<0.05.

5. Interference pigment according to claim 1, characterised in that the colourless material having a refractive index≧1.8 is selected from TiO₂, titanium dioxide hydrate, ZnO, ZrO₂ and/or mixed phases thereof.

6. Interference pigment according to claim 1, characterised in that the colourless material having a refractive index n≧1.8 consists of TiO₂ or TiO₂₋ₓ where 0.001≦x<0.05 and is in the rutile crystal modification.

7. Interference pigment according to claim 1, characterised in that the colourless material having a refractive index n<1.8 is selected from SiO₂, Al₂O₃, silicon oxide hydrate, aluminium oxide hydrate, MgF₂, or from mixtures of two or more thereof.

8. Interference pigment according to claim 1, characterised in that each layer comprising a colourless material having a refractive index n≧1.8 consists of TiO₂₋ₓ where 0.001≦x<0.05.

9. Interference pigment according to claim 1, characterised in that the layer of TiO₂₋ₓ is doped with 0.1 to 3 mol % of Sn.

10. Use of transparent, optically variable, electrically semiconducting, flake-form interference pigments according to claim 1 in paints, coatings, printing inks, plastics, sensors, security applications, floorcoverings, textiles, films, ceramic materials, glasses, paper, for laser marking, in heat protection, as photosemiconductors, in pigment-containing formulations, pigment preparations and dry preparations.

11. A mixture comprising one or more interference pigments according to claim 1, and organic and/or inorganic colorants and/or electrically conducting materials and/or non-electrically conducting effect pigments.

12. The mixture according to claim 11, wherein said mixture contains two or more interference pigments which are different from one another, each of which has a TiO₂₋ₓ layer where 0.001≦x<0.05, where these interference pigments differ in the support material, in the composition of the layers, in the number of layers, in the interference color, in the color flop and/or in the electrical conductivity.

13. The mixture according to claim 11, wherein said mixture is employed in security products which are subjected to the influence of an electromagnetic field.

14. Security product containing interference pigments according to claim 1.

15. Security product according to claim 14, characterised in that it is a bank note, a cheque, a credit card, a share, a passport, an identity document, a driving licence, an entry ticket, a revenue stamp or a tax stamp.
